(19) United States
(12) Patent Application Publication
(10) Pub. No.: US 2014/0330530 A1
(43) Pub. Date: Nov. 6, 2014

(54) METHOD AND DEVICE FOR DETERMINING A TRAJECTORY OF AN AQUEOUS FLOW, AND AUTONOMOUS PROBE IMPLEMENTED IN SAID METHOD

(71) Applicants: Severin Pistre, Saint Gely Du Fesc (FR); Pascal Falgayrettes, Montpellier (FR); Vivien Hakoun, Montpellier (FR)

(72) Inventors: Severin Pistre, Saint Gely Du Fesc (FR); Pascal Falgayrettes, Montpellier (FR); Vivien Hakoun, Montpellier (FR)

(73) Assignees: CENTRE NATIONAL DE LA RECHERCHE SCIENTIFIQUE, Paris (FR); UNIVERSITE MONTPELLIER 2 SCIENCES ET TECHNIQUES, Montpellier (FR)

(21) Appl. No.: 14/366,452

(22) PCT Filed: Dec. 13, 2012
(86) PCT No.: PCT/FR2012/052918

§ 371 Date: Jun. 18, 2014

(30) Foreign Application Priority Data
Dec. 20, 2011 (FR) 1161985

(51) Int. Cl. G01V 9/02

(52) U.S. Cl. CPC G01V 9/02
USPC 702/50

(57) ABSTRACT

A method for determining a trajectory of an aqueous flow, implementing a mobile autonomous measurement device inserted into the aqueous flow, includes a step of measuring and a step of saving acceleration data in a reference base of the mobile device, and a step of processing data collected during the step of measuring to determine the trajectory by double integration of the processed data.

The invention relates to a method and device for determining a trajectory of an aqueous flow, in particular for mapping a complex environment that is inaccessible, or difficult to access, such as a karst aquifer. The aqueous can also be constituted by an underground conduit, mine, various channels or also a river. It also relates to an autonomous probe implemented in this method.

### STATE OF THE PRIOR ART

An aquifer is a rocky formation which is sufficiently porous and permeable to contain groundwater and allow it to flow. Groundwater is a natural reserve of fresh water capable of being exploited.

A distinction is made between porous aquifers and fissured and karstified aquifers.

In porous aquifers, water is contained in the open pores of the rock and can flow therein (sands, chalk, gravels, sandstone, volcanic scoria, etc.). The permeability there is due to matrix and depends on the dimension of the pores. In fissured aquifers, the water is contained and flows in the faults, fissures or joints in the rock (limestones, granites, basalts, etc.). The permeability there is mainly due to fissures and depends on the size and connection of the fissures or faults.

Karst aquifers are basically fissured aquifers in which the water flowing in the fissures has progressively dissolved the rock. This dissolution results in the creation of cavities and organized drains of variable sizes in which the water can flow very rapidly in comparison with porous or even fissured aquifers. The management of these aquifers (abstraction of drinking water, transport of pollutants, etc.) still remains difficult due to almost total ignorance of the drainage network. Any method making it possible to map, even partially, this drowned network would make it possible to considerably improve their management.

The great depths reached by the networks of conduits do not allow use of mapping systems such as GPS.

Methods are known that in some cases make it possible to find the outlet or outlets of a karst aquifer, in particular based on the injection of dyes upstream. These methods are widely used but provide no information other than the outlet point or points downstream of the upstream injection point with which one or more transit times are associated. Such methods make it possible to establish any hydraulic connections but do not make it possible to map the flow trajectory.

Devices are known, such as robots which can be moved within the karst drains, making it possible to map them.

However, these devices are costly and often become trapped when they return downstream to deliver the recorded mapping.

Moreover, the autonomy of the devices is limited by the battery they carry.

Furthermore, these devices can pollute the water resource by remaining trapped in the network. It must be noted that this water may be abstracted for supplying drinking water.

Moreover, these robots are not small in size, which means that their passage through narrow sections of the network cannot be envisaged.

Finally, these robots are active systems using motors in order to move, which also increases their energy consumption.

Finally, US 2010/0274488 is known, which discloses a device and method for mapping a complex, poorly accessible underground network. This device discloses the use of ultrasound sensors the function of which is to map the environment in three dimensions. The measurements obtained by the ultrasound sensors make it possible to carry out a triangulation of the environment. This triangulation can be affected by sudden movements of the device during the measurements by ultrasound sensor. Thus an accelerometer is disclosed to make it possible to measure such sudden movements and to be able to take account of them during the use of measurements obtained by the ultrasound sensors.

This document also discloses the use of a magnetometer in order to allow the device to determine magnetic north.

However, the multiplicity of the sensors correspondingly reduces the duration of operation of the device by increasing the consumption of energy provided by the battery.

Moreover, this multiplicity leads to a high cost of the device and to a significant space requirement.

Finally, this device uses a battery cell as energy resource. This battery cell is by nature an environmental pollutant in the event of the device remaining trapped in the underground network.

A purpose of the invention is to overcome at least one of these drawbacks.

Another purpose of the invention is to propose a device and a method for mapping aqueous flows.

Another purpose of the invention is to propose such a device and method that is less costly than the known devices.

Another purpose of the invention is to propose such a device and method for allowing device to pass through sections of the network narrower than those through which the devices according to the state of the art can pass.

Another purpose of the invention is to propose a device capable of being inserted into the aquifer environment using a borehole.

Another purpose of the invention is to propose such a device and method that is passive, i.e. does not require the use of a motor for its movement.

Another purpose of the invention is to propose such a device and method with very great autonomy.

Another purpose of the invention is to propose a non-polluting device and method for use in potable water from the aquifer when the device remains trapped.

### DISCLOSURE OF THE INVENTION

At least one of the abovementioned objectives is obtained with a method for determining a trajectory of an aqueous flow, utilizing an autonomous mobile measurement device introduced into said aqueous flow, comprising:

a step of measuring and storing acceleration data in a reference system of said mobile device, and
a step of processing data collected during said measuring step in order to determine said trajectory by double integration of the processed data.

A method is thus proposed making it possible to develop a device for mapping aqueous flows. As a trajectory in this environment is determined directly from the acceleration data collected by the device, the latter is smaller in size than those proposed in the state of the art and less costly than the latter. It is thus possible to insert it into an aqueous environment by using a borehole and it is able to pass through sections of network that are narrower than those through which the devices of the prior art can pass.

Furthermore, the step of processing the stored data can moreover comprise: a step of eliminating a bias on the stored data in order to produce filtered data, a step of projecting the filtered data onto the terrestrial reference system.

Biases can be recorded in the measurements. These biases are mainly due to a fluctuation in the supply of means for measuring an acceleration or due to a variation of a physical parameter during the step of measuring acceleration data. These biases then introduce a slow drift in the measured data and elimination thereof can then be carried out by frequential processing of the signal, eliminating these very low frequencies.

The step of projecting the filtered data onto the terrestrial reference system can be carried out by making an assumption about the speed of rotation of the device in the aqueous environment and determining the orientation of the probe by processing the acceleration data.

The measurement step can also comprise measuring the magnetic orientation of the device, storing magnetic orientation data and processing the magnetic orientation data stored at the time of projection of the filtered data onto the terrestrial reference system.

It is thus possible to determine the rotation angles of the device with respect to the terrestrial magnetic north without making an assumption about the orientation of terrestrial gravity. The step of projecting the filtered data onto the terrestrial reference system is thus simplified.

The method according to the invention can also comprise a step of determining the orientation of the reference system of the mobile device in the terrestrial reference system, by using:

a determination of the gravity vector component in the reference system of said mobile device obtained from the acceleration data, and
a measurement of the magnetic orientation of said mobile device in the terrestrial magnetic field.

It can also comprise a step of correcting the determined trajectory by double integration of the processed data, comprising:

determining an aggregate error over said trajectory, by comparing the geographical location of an arrival point of the mobile device with the location of said arrival point obtained from said trajectory, and
correcting said aggregate error by applying to said trajectory a rotation around a departure point of the mobile device and a homothetic transformation.

The departure and arrival points correspond respectively to the geographical or topological location of the beginning and end of the aqueous flow trajectory.

The measurement step can also comprise measuring rotation angles of said device, storing rotation angle measurement data and processing the rotation angle data stored at the time of projection of the filtered data onto the terrestrial reference system.

This measurement of rotation angles of the device can be carried out by a gyroscope comprised within the device and it is then no longer necessary to making an assumption about the orientation of terrestrial gravity. The step of projecting the filtered data onto the terrestrial reference system is thus simplified.

Advantageously, the method according to the invention can also comprise a step of producing energy for the device, originating from a water corrosion cell. Thus, the device can be made lighter and less bulky since it need not comprise a battery. This enables it to pass through narrower aqueous flows than the known devices. Moreover, its lifetime is almost infinite and it is thus less costly than the known devices. Finally, it is less polluting than the known devices when it remains trapped in a aqueous flow if the metal pair chosen is acceptable for the flow/environments under study.

According to another aspect of the invention, a system is proposed for determining a trajectory of a aqueous flow, implementing the method according to the invention, comprising:

means for measuring accelerations of a mobile device introduced into the aqueous flow, in the three spatial dimensions, and
means for processing the acceleration data provided by said acceleration measurement means, said data processing means being provided in order to determine a trajectory of the aqueous flow.

The system according to the invention can moreover comprise:

means for measuring the magnetic orientation of the mobile device, and
means for processing the magnetic orientation data supplied by said means in order to measure the magnetic orientation (208).

According to another aspect of the invention, an autonomous probe is proposed for determining a trajectory of a aqueous flow comprising:

means for measuring accelerations of the probe in the three spatial dimensions,
storage means for recording the acceleration measurements.

The means for measuring accelerations may be capable of producing a measurement of acceleration in a frequency range starting from continuous, and a high-pass filtered acceleration measurement in which the continuous component is eliminated.

In addition, an autonomous probe according to the invention can also comprise means for measuring and recording the magnetic orientation of said probe.

Advantageously, an autonomous probe according to the invention can also comprise means for measuring and recording rotation angles of the device.

In particular, an autonomous probe according to the invention can also comprise power supply means comprising two metal electrodes and an electrolyte containing liquid originating from said aqueous environment.

According to another aspect of the invention, an electronic appliance is proposed for determining a trajectory of a aqueous flow, implemented in a system according to the invention, comprising:

means for acquiring the data recorded by an autonomous probe according to the invention, and
means for processing the acquired data, in order to determine said trajectory by double integration of the processed data.

In addition, the data processing means can moreover comprise:

data filtering means for eliminating a bias from the acquired data, and
means for projecting said filtered data onto the terrestrial reference system.

Thus, the invention proposes an effective solution that is simple to implement in order to map karst aquifer-type networks.

The invention can moreover be implemented for all types of similar applications. It can thus be used for example for:
mapping or characterizing the transport of particles within a flow in a fluid in an underground environment and/or in an inaccessible or confined environment;
controlling the flow of an effluent in an underground network such as a wastewater or rainwater network, and, for example, identifying areas of “dead water” (in which speeds are zero for a given series of measurements) and “recirculation” areas (in which the trajectory indicates local loops) in the course of its journey.

The probe according to the invention can also comprise additional sensors, such as for example temperature and/or electrical conductivity sensors, which make it possible to obtain information on physical and chemical parameters of the surrounding environment.

This information can for example be used to identify local incoming flows of specific fluids (for example an inflow of water) at the confluence of two drains transporting waters having different physical and chemical characteristics. Mapping can thus be achieved in the space of these confluence zones.

### DESCRIPTION

Other advantages and features of the invention will become apparent on reading the detailed description of implementations and of an embodiment which is in no way limitative, and the attached diagrams, in which:

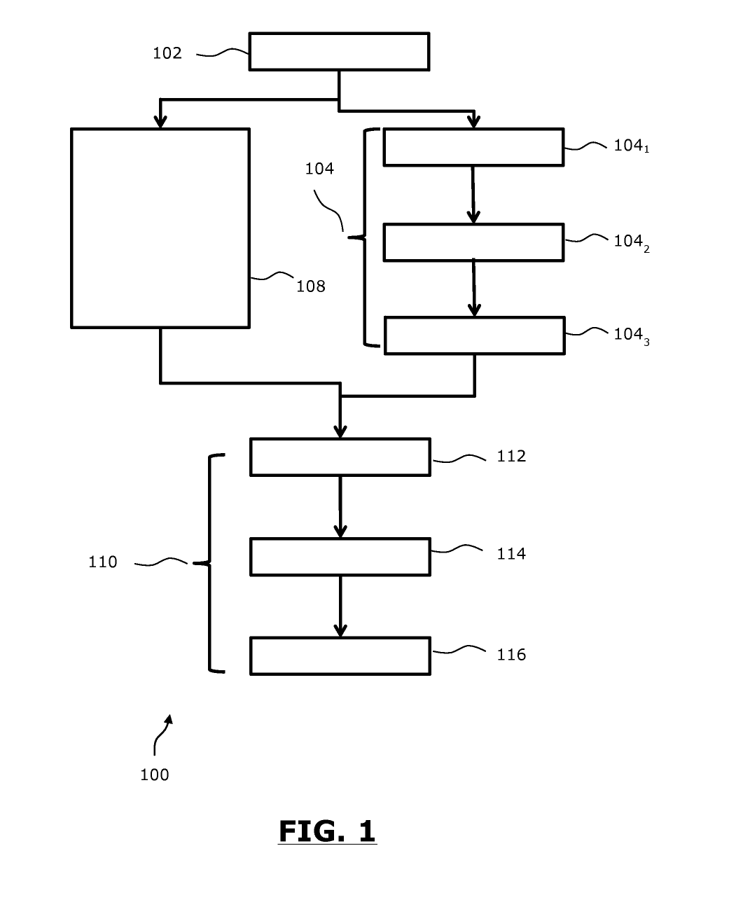

FIG. 1 is a diagrammatic representation of a method according to the invention,

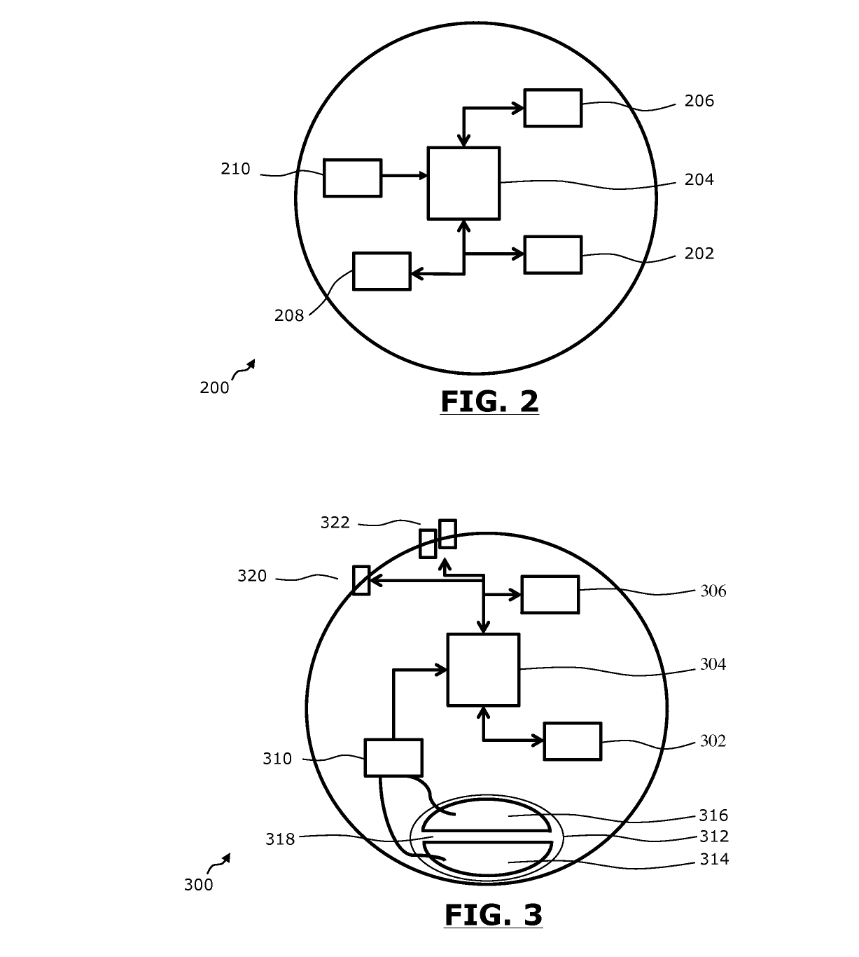

FIG. 2 is a diagrammatic view of a system according to the invention;

FIG. 3 is a diagrammatic view of a probe according to the invention;

FIG. 1 shows an embodiment of a method 100 for determining a trajectory of an aqueous flow according to the invention.

The method 100 comprises:

a step 102 of introducing an autonomous mobile measurement device into the aqueous flow, then
a step 104 of measurement of data and storage of data,
a step 108 of generating energy for the device,
a step (not shown) of recovery of the autonomous mobile measurement device from the aqueous flow,
a step 110 of processing data collected during the measuring step 104 and determining the trajectory by double integration of the processed data.

Step 104 of measuring data and storage of the data also comprises:

a step 104₁ of measuring data at regular time intervals. The time interval is adjustable,
a step 104₂ of conversion of these measurements into n bits by an analogue/digital converter of a microcontroller incorporated in the device, and
a step 104₃ of recording these data in a memory card incorporated in the device.

The data measured are the accelerations undergone by the device in a reference system of the mobile device.

Other data are measured and stored, such as the conductivity of the water, its temperature as well as the recording of the direction of magnetic north using a magnetic compass.

The power generation step 108 for the device consists of using the energy originating from the corrosion of a metal, or a pair of metals, in an aqueous environment in order to form a corrosion cell. The corrosion results from the simultaneous existence of two electrochemical reactions: the reaction situated at the anode which corresponds to the oxidation of the metal—which generally produces an oxide which passes into solution in the water—and the reaction at the cathode which corresponds to the reduction of the oxidant. This generation of energy consists of using the water in the aqueous environment as electrolyte. This makes it possible to avoid the saturation of the electrolyte of a conventional battery, due to the renewal thereof in the aqueous environment. Furthermore, the device then has a lower weight because it does not carry any electrolyte. The change in mass of the probe during the consumption of the energy resource constituted by the metal leads to an increase in buoyancy and, as a result, to the risk of flotation of the device.

The potential available at the terminals of such a corrosion cell is low. A step (not shown) of raising by a charging pump-type circuit is thus proposed. Furthermore, a capacitance is progressively charged by this charging pump circuit in order to regulate the voltage but also to provide the highest peak of current at the time of writing the data measured during step 104₃.

Step 110 of processing data collected during the step of measurement 104 and determination of the trajectory by double integration of the processed data comprises:

a step 112 of acquisition of the data collected by the autonomous probe,
a step 114 of eliminating a bias of the data acquired in order to produce filtered data, and
a step 116 of projection of the filtered data onto the terrestrial reference system.

During step 114, a first bias linked to the acceleration measurement sensor which has a slight drift is corrected. This drift can originate in the power supply to the sensor which fluctuates slightly throughout recording. This drift can also originate in a physical parameter, such as for example the variation in temperature. In both these cases, the drift is slow and the correction is carried out by frequential processing by eliminating the very low frequencies.

During step 116, the sensor's own trajectory is taken into account. In fact, the data are recorded in the reference system of the probe and the latter undergoes random rotations due to the effect of currents. The rotation angles of the probe are determined by processing the data originating from the use of a magnetic compass. The data recorded in the reference system of the probe are then projected onto the terrestrial reference system.

Finally, step 116 is achieved by calculating a double integration of the acceleration in the terrestrial reference system in order to calculate the speed, then the position of each measurement point.

In a variant of the embodiment of the method, the rotation angles of the probe are determined directly by the processing of data collected by a gyroscope incorporated in the probe.

In another variant of the embodiment of the method, the orientation of the probe is determined by processing the acceleration data. The direction of gravity is then considered as a constant.

FIG. 2 shows a probe 200 for determining a trajectory of a aqueous flow.

The probe 200 comprises a three-dimensional accelerometer 202 for measuring accelerations in the three spatial dimensions.

The probe 200 also comprises a microcontroller 204 in a two-way connection with the accelerometer 202.

The probe 200 also comprises an SD card 206. This card is in two-way connection with the microcontroller 204. The data measured by the accelerometer 202 are recorded in the SD memory 206.

The probe 200 also comprises a three-directional magnetic compass 208 for measuring and recording the magnetic orientation of the probe 200.

It also comprises a power supply unit 210. This power supply unit is connected to a conventional or corrosion cell (not shown) and supplies the electronic circuits via the microcontroller 204.

In the absence of ballast in particular, the magnetic compass 208 makes it possible to record the rotations of the probe 200 with respect to the reference system of the probe (or in other words the rotations of the terrestrial magnetic field in the reference system of the probe) and thus to be able to project the collected acceleration onto the terrestrial reference system.

As FIG. 2 is a basic view of a first embodiment of a probe according to the invention, the acceleration measurement and magnetic compass functionalities have been separated. In reality, these functionalities are implemented within a single MEMS (Micro-Electro-Mechanical Systems) sensor of a type which is capable of measuring the acceleration and the magnetic orientation of the probe. As these functionalities are incorporated in a single sensor, the reference measurement system is then the same for both types of measurement.

FIG. 3 represents an autonomous probe 300 for determining a trajectory of an aqueous flow.

The autonomous probe 300 comprises a three-dimensional accelerometer 302 for measuring accelerations in the three spatial dimensions.

The probe 300 also comprises a microcontroller 304 in a two-way connection with the accelerometer 302.

The probe 300 also comprises an SD card 306. This card is in a two-way connection with the microcontroller 304. The data measured by the accelerometer 302 are recorded in the SD memory 306.

It also comprises a power supply unit 310. The power supply unit 310 provides energy to the remainder of the circuit via the power supply of the microcontroller 304. This power supply unit is connected to a modified corrosion cell 312 and supplies the electronic circuits via the microcontroller 304.

The corrosion cell 312 comprises two electrodes 314 and 316. The electrolyte 318 is constituted by liquid originating from the aqueous environment into which the autonomous probe 300 is introduced. The electrode 316 is constituted by magnesium and acts as an anode. The electrode 314 is constituted by copper and acts as a cathode. In this case, the magnesium being the most reducing metal, it is oxidized by the electrolyte 318 and releases electrons.

The change in mass of the probe, during the consumption of the energy resource constituted by the metal, leads to an increase in buoyancy and, consequently, to the risk of flotation of the device. In order to counter this effect, the corrosion cell 312 is designed to allow the electrolyte originating from the aqueous environment to enter and leave. Thus, when the quantity of magnesium is reduced, the volume of electrolyte originating from the aqueous environment inside the corrosion cell increases, and thus reduces the buoyancy resulting from the consumption of the energy resource.

Designed in this way, the corrosion cell also has the function of acting as ballast for the probe 300. The ballast has the function of correcting the list or the trim, and improving the stability of the probe by modifying the position of its centre of gravity.

The probe 300 also comprises a temperature sensor 320 and of the conductivity measurement cells 322. The temperature sensors 320 and the conductivity measurement cells 322 are independently linked to the microcontroller 304. The data relating to the temperature and to the conductivity are recorded in the SD card 306.

In another embodiment, the probe can also comprise a three-directional magnetic compass for measuring and recording the magnetic orientation of the probe. This magnetic compass can for example be included in the probe 300 shown in FIG. 3.

In the absence of ballast in particular, the magnetic compass makes it possible to record the rotations of the probe in the reference system of the probe (or in other words the rotations of the terrestrial magnetic field in the reference system of the probe) and thus to be able to project the acceleration data collected onto the terrestrial reference system.

It is also possible to use data recorded in a gyroscope.

An embodiment and implementation of the invention for determining a trajectory of an aqueous flow will now be described more precisely.

As explained previously, the invention is implemented in the form of a system which comprises:
an autonomous probe 200, which is intended to be inserted into a flow at an entry point and recovered at an exit point; and
an electronic device with calculation means for processing the data recorded by the probe 200 during its journey in the flow. In practice, this device is a computer with a reader for reading the data recorded on the memory card of the probe 200.

The probe 200 comprises a 3-axis accelerometer 202 which makes it possible to carry out acceleration measurements in 3 dimensions (3D). This accelerometer makes it possible to obtain two types of measurements:
a “complete” acceleration measurement y_{c} which comprises the gravity acceleration component g to which the acceleration vector linked to the movement y is added vectorially,
a “filtered” acceleration measurement y_{f} from which the continuous component, corresponding to gravity, is eliminated by high-pass digital filtering at very low frequency (of the order of 0.25 Hz). This “filtered” acceleration measurement y_{f} corresponds to the acceleration vector linked to the movement y(y_{f}=y).

The probe 200 also comprises a magnetic compass 208 which carries out measurements of the orientation of the terrestrial magnetic field in three dimensions, in the reference system of the probe 200. This measurement is an absolute measurement.

This set of acceleration and magnetic field measurements makes it possible in particular to overcome the effects of the inclination of the probe 200 with respect to its horizontal position, which can occur even if said probe is weighted (for example by the electrodes 314, 316 of the cell 312).

Firstly, the probe 200 is inserted into the flow (step 102 of the measurement method as shown in FIG. 1).

The probe 200 performs and then records “complete” and “filtered” acceleration measurements alternately throughout its journey in the flow (step 104 of the measurement method as shown in FIG. 1).

Then, the probe 200 is recovered and its data are analyzed.

During data processing step 110, or more precisely during step 116 of projection of the filtered data onto the terrestrial reference system, the following operations are carried out:
the vectorial gravity acceleration component g is determined by subtracting the “filtered” acceleration vector y_{f} from the “complete” acceleration vector y_{c}. This makes it possible to determine, for each measured item of data, the angular difference between the Z′ axis of the reference system of the probe and the Z axis of the terrestrial reference system (the Z axis of which is directed towards the centre of the earth, and the X and Y axes of which are in the local horizontal plane at the measurement site);
in addition, the orientation of the terrestrial magnetic field given by the magnetic compass 208 is used to orient the X′ and Y′ axes of the reference system of the probe with respect to magnetic north, and therefore to the X and Y axes of the terrestrial reference system. The complete orientation of the probe in the terrestrial fixed reference system is thus obtained at any time during its journey. This orientation can be defined for example by heading, pitch and roll angles between the respective axes of the terrestrial reference system (X, Y, Z) and the reference system of the probe (X′, Y′, Z′);
the “filtered” acceleration vector y_{f}, is then incorporated so as to determine the instantaneous speed of the probe 200 at each point of the flow, in the reference system of the probe (X′, Y′, Z′);
by using the angles of inclination calculated previously, the velocity vector of the probe is projected onto the terrestrial reference system (X, Y, Z) via a series of 3 rotations;
finally, the position of the probe 200 is calculated by integration of the components of the velocity vector on the 3 axes of the terrestrial reference system (X, Y, Z).

When the trajectory is completely determined, a final correction is made by combining the topographical data (map or GPS coordinates) with those originating from the probe 200.

The point of departure of the probe 200, as well as that of arrival, are known and are used to calculate a scaling factor for the trajectory measured by the probe. This scaling factor makes it possible to correct the drift of the accelerometer sensor. This error due to drift is cumulative. It can become significant because the acceleration is integrated in order to obtain the speed. This correction comprises the following steps:
using the topographical coordinates, a reference straight line segment corresponding to the trajectory of the flow is determined. This reference straight line segment links the point of departure and the point of arrival of the probe 200 in topographical coordinates. It is defined by a length and an orientation;
a measurement straight line segment is then calculated, which links the point of departure and the point of arrival of the trajectory of the probe calculated previously;
the difference, in length and orientation, between reference and measurement straight-line segments makes it possible to calculate a correction to be applied to the set of the points of the trajectory calculated in order to be able to match the points of departure and arrival determined on the plane and from the trajectory of the probe respectively. This correction can for example comprise a rotation about the point of departure and a homothetic transformation, with a scaling factor.

Of course, the invention is not limited to the examples which have just been described and numerous adjustments can be made to these examples without exceeding the scope of the invention.

1. Method for determining a trajectory of an aqueous flow, utilizing an autonomous mobile measurement device (200, 300) introduced into said aqueous flow, comprising:
a step of measuring (104) and storing acceleration data in a reference system of said mobile device (200), and
a step of processing (110) data collected during said measuring step (104) in order to determine said trajectory by double integration of the processed data.

2. Method according to claim 1, characterized in that the step of processing (110) the stored data also comprises:
a step of eliminating a bias (114) from said stored data in order to produce filtered data, and
a step of projecting (116) said filtered data onto the terrestrial reference system.

3. Method according to claim 1, characterized in that the measurement step (104) also comprises a measurement of the magnetic orientation of said device, storing magnetic orientation measurement data and processing the stored magnetic orientation data at the time of projection of the filtered data onto the terrestrial reference system.

4. Method according to claim 3, characterized in that it also comprises a step of determining the orientation of the reference system of the mobile device (200, 300) in the terrestrial reference system, using:
a determination of the gravity vector component in the reference system of said mobile device obtained from acceleration data, and
a measurement of the magnetic orientation of said mobile device in the terrestrial magnetic field.

5. Method according to claim 1, characterized in that it also comprises a step of correction of the trajectory determined by double integration of the data processed, comprising:
determining an aggregate error over said trajectory, by comparing the geographical location of a point of arrival of the mobile device (200, 300) with the location of said arrival point obtained from said trajectory, and
correcting said global error by applying to said trajectory a rotation around a departure point of the mobile device (200, 300) and a homothetic transformation.

6. Method according to claim 1, characterized in that the measurement step (104) also comprises measuring rotation angles of said device, storing rotation angle measurement data and processing the stored rotation angle data at the time of projection of the filtered data onto the terrestrial reference system.

7. Method according to claim 1, characterized in this that it also comprises a step of producing energy (108) for the device (200, 300), originating from a water corrosion cell (312).

8. System for determining a trajectory of a aqueous flow, implementing the method according to claim 1, comprising:
means for measuring accelerations (202, 302) of a mobile device (200, 300) introduced into the aqueous flow, in the three spatial dimensions, and
means for processing the acceleration data provided by said acceleration measurement means (202, 302), said data processing means being provided in order to determine a trajectory of the aqueous flow.

9. System according to claim 8, characterized in that it also comprises:
means for measuring the magnetic orientation (208) of the mobile device (200, 300), and
means for processing magnetic orientation data provided by said means for measuring the magnetic orientation (208).

10. Autonomous probe (200, 300) for determining a trajectory of an aqueous flow comprising:
means for measuring accelerations (202, 302) of said probe (200, 300) in the three spatial dimensions, and
storage means (206, 306) for recording said acceleration measurements.

11. Autonomous probe (200, 300) according to claim 10, characterized in that the means for measuring accelerations (202, 302) are capable of producing an acceleration measurement in a frequency range starting from continuous, and a high-pass filtered acceleration measurement in which the continuous component is eliminated.

12. Autonomous probe according to claim 10, characterized in that it also comprises means for measuring and recording the magnetic orientation (208) of said probe (200, 300).

13. Autonomous probe according to claim 10, characterized in that it also comprises means for measuring and recording rotation angles of the device.

14. Autonomous probe according to claim 10, characterized in that it also comprises power supply means (312) comprising two metal electrodes (314, 316) and an electrolyte (318) containing liquid originating from said aqueous environment.

15. Electronic device for determining a trajectory of an aqueous flow, comprising:
means for acquiring the data recorded by an autonomous probe (200, 300) according to claim 10, and
means for processing the acquired data, in order to determine said trajectory by double integration of the processed data.

16. Electronic device according to claim 15, characterized in that the data processing means also comprise:
data filtering means for eliminating a bias from the acquired data, and
means for projecting said filtered data onto the terrestrial reference system.

17. Method according to claim 2, characterized in that the measurement step (104) also comprises a measurement of the magnetic orientation of said device, storing magnetic orientation measurement data and processing the stored magnetic orientation data at the time of projection of the filtered data onto the terrestrial reference system.

18. Autonomous probe according to claim 11, characterized in that it also comprises means for measuring and recording the magnetic orientation (208) of said probe (200, 300).
